(19) United States
(12) Patent Application Publication
(10) Pub. No.: US 2012/0207074 A1
(43) Pub. Date: Aug. 16, 2012

(54) TRANSMITTING MULTIPLE GROUP-ADDRESSED FRAMES IN A WIRELESS NETWORK

(75) Inventor: Jarkko Kneckt, Espoo (FI)

(73) Assignee: NOKIA CORPORATION, Espoo (FI)

(21) Appl. No.: 13/024,693

(22) Filed: Feb. 10, 2011

(51) Int. Cl. H04H 20/71

(52) U.S. Cl. 370/312

(57) ABSTRACT

Various example embodiments are disclosed herein. According to an example embodiment, a method includes obtaining, by a first device, a transmission opportunity in a wireless network, transmitting to a second device a first message that includes a non-zero duration field indicating a duration of the transmission opportunity, and receiving a second message from the second device in response to the first message, wherein the second message includes a non-zero duration field identifying a remaining duration of the transmission opportunity. The method also includes transmitting, from the first device, a plurality of group-addressed frames before the duration of the obtained transmission opportunity expires, in response to receiving the second message.

### TECHNICAL FIELD

This description relates to the transmission of group-addressed frames in wireless networks.

### BACKGROUND

In some wireless networks, virtual carrier-sense and physical carrier-sense functions may be used to determine the availability of the shared medium or channel. For example, the medium may be considered to be idle in some cases when both of these two functions indicate that the medium is idle. While the physical carrier-sense function uses the physical layer to sense the carrier, the virtual carrier-sense function is based on the Network Allocation Vector (NAV). For example, in some wireless networks, some MAC (Media Access Control) frames may carry a duration field, which may be used to reserve the medium (or channel) for a fixed time period for transmission of unicast frames. The NAV may be considered a timer that indicates the amount of time for which the medium has been reserved. Transmitting nodes may typically set their NAV timers (using the duration field in frames) to the time for which they expect to use the medium, including the transmission time of all the frames in a sequence. Other nodes in the network may set up a process to count down the NAV (a locally stored copy of the NAV information). When the NAV is greater than zero, the virtual carrier-sense function indicates that the medium is busy. When the NAV reaches zero, the medium is reported to be idle.

In addition, wireless nodes may use a Request-to-Send (RTS) and Clear-to-Send (CTS) exchange to request permission to use the medium to transmit unicast frames. A requesting node may typically send a RTS, and then receive a CTS. The CTS may indicate that the channel or medium is idle or available and may serve to warn other nodes that the medium is now busy.

### SUMMARY

According to an example embodiment, an apparatus may include at least one processor, and at least one memory including computer program code. The at least one memory and the computer program code are configured to, with the at least one processor cause the apparatus to at least: obtain, by a first device, a transmission opportunity in a wireless network, transmit to a second device a first message that includes a non-zero duration field indicating a duration of the transmission opportunity, and receive a second message from the second device in response to the first message. The second message includes a non-zero duration field identifying a remaining duration of the transmission opportunity. The apparatus is also configured to transmit, from the first device, a plurality of group-addressed frames before the duration of the obtained transmission opportunity expires, in response to receiving the second message.

According to an example embodiment, a method includes obtaining, by a first device, a transmission opportunity in a wireless network, transmitting to a second device a first message that includes a non-zero duration field indicating a duration of the transmission opportunity, and receiving a second message from the second device in response to the first message. The second message includes a non-zero duration field identifying a remaining duration of the transmission opportunity. The method also includes transmitting, from the first device, a plurality of group-addressed frames before the duration of the obtained transmission opportunity expires, in response to receiving the second message.

A computer program product tangibly embodied on a computer-readable storage medium having executable-instructions stored thereon, the instructions being executable to cause a processor to: obtain, by a first device, a transmission opportunity in a wireless network, transmit to a second device a first message that includes a non-zero duration field indicating a duration of the transmission opportunity, and receive a second message from the second device in response to the first message. The second message includes a non-zero duration field identifying a remaining duration of the transmission opportunity. The processor is further caused to transmit, from the first device, a plurality of group-addressed frames before the duration of the obtained transmission opportunity expires, in response to receiving the second message.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example implementation.

FIG. 2 is a diagram illustrating the transmission of multiple group-addressed frames in one transmission opportunity (TXOP) based on the use of request-to-send (RTS) and clear-to-send (CTS) messages.

FIG. 3 is a diagram illustrating the transmission of multiple group-addressed frames in one transmission opportunity (TXOP) based on the use of a block acknowledgement request (or block ack request) for group-addressed frames and a block acknowledgement for one or more group-addressed frames.

FIG. 4 is a block diagram of an example implementation of a wireless station, or a system or that may be provided at or as part of a wireless station.

FIG. 5 is a block diagram of a wireless station 500 according to another example implementation.

FIG. 6 is a flow chart illustrating operation of a wireless station according to an example implementation.

### DETAILED DESCRIPTION

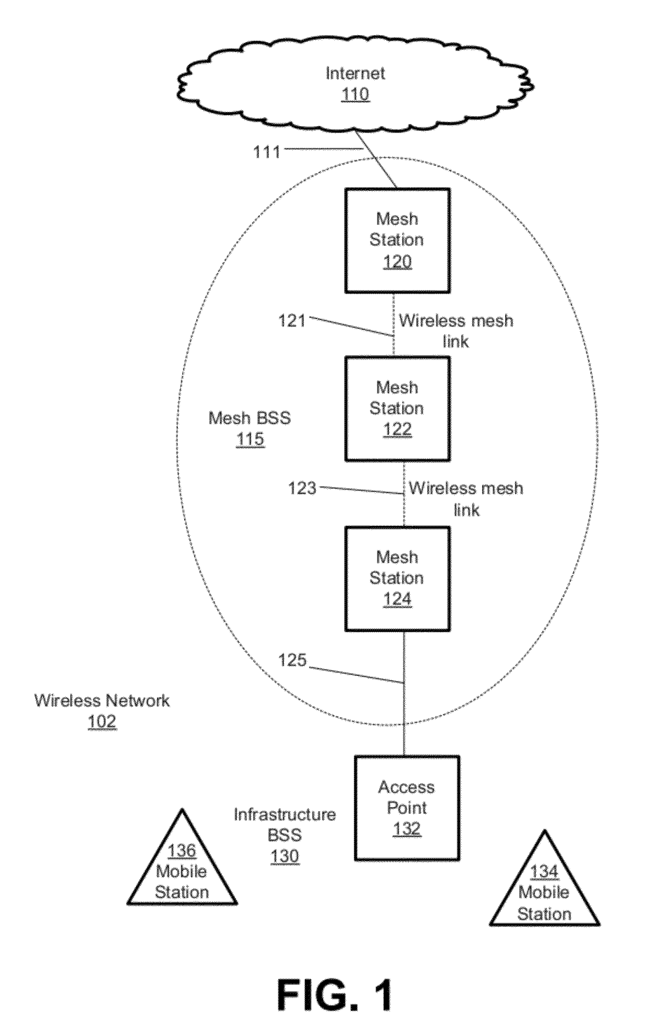

FIG. 1 is a block diagram of a wireless network 102 according to an example implementation. Wireless network 102 may include a mesh network or mesh basic service set (mesh BSS or MBSS) 115 that may include one or more mesh stations, such as mesh stations 120, 122 and 124. Mesh network 115 may be coupled to another network, such as the Internet 110. An infrastructure basic service set (IBSS), such as an IEEE 802.11 WLAN IBSS network 130 may also be provided (for example), and may include an access point (or base station) 132, and multiple wireless stations or mobile stations, including mobile stations (or wireless stations) 134 and 136. Mesh station 120 may, for example, be considered a mesh portal since mesh station 120 is connected both to the mesh network 115 via wireless mesh link 121 and to the Internet via link 111 (which may be a wired or wireless link). Mesh station 122, which may be a mesh point (for example), may be coupled to mesh station 120 via wireless mesh link 121. Mesh station 124 may be a mesh point (for example) and may be coupled to mesh station 122 via wireless mesh link 123. Mesh station 124 may be coupled to access point (AP) 132 via link 125 (which may be wired or wireless).

Although not required, in one example implementation, mesh network 115 may include one or more mesh stations (e.g., where the mesh stations of mesh network 115 may each be a mesh point, mesh portal, or mesh access point) in accordance with IEEE 802.11s. IEEE 802.11s is an extension to the IEEE 802.11 standard. The mesh stations in an IEEE 802.11s mesh network may form a multi-hop wireless infrastructure to provide wireless interconnection between various wireless stations.

In an example implementation, mesh network 115 may be an IEEE 802.11s mesh network or mesh BSS (mesh basic service set). In such example implementation, mesh stations 120, 122 and 124 may use a Peer Link Management protocol to discover neighboring wireless nodes (that are within range of the mesh station) and keep track of such neighboring nodes. For communicating with nodes that are farther than one hop, the mesh stations within mesh network 115 may support Hybrid Wireless Mesh Protocol (HWMP) to provide path or route selection for frames, e.g., to find a route or path to a node that is not an immediate neighbor. HWMP is very similar to a routing protocol, but 802.11s uses MAC (media access control) addresses for routing (instead of IP addresses for routing), and thus, may be referred to as path selection. Path selection via HWMP may be performed using path request and path reply messages. Once a device is configured as a mesh station (e.g., configured as a mesh point, mesh portal, or mesh access point), the mesh station typically begins transmitting a beacon, and other nodes (or mesh stations) that are in range of the beacon initiate the Peer Link Management Protocol to establish communication or peerings (or peer relationships) between mesh stations.

The network(s) shown in FIG. 1 are merely one example implementation that is provided for explanation, and many other different kinds or types of networks and different wireless technologies may be used. The wireless network 102 may include devices, nodes or wireless stations of a variety of different technologies, including, for example, IEEE 802.16 Wireless Metropolitan Area Network (WiMAX), an IEEE 802.11 Wireless Local Area Network (WLAN), or a cellular telephone network, Wireless Gigabit Alliance (WGA) standards, Long Term Evolution (LTE), or variations or derivatives thereof, or any other wireless standard or technology. These are merely a few examples and the disclosure is not limited thereto.

Currently, NAV protection is not provided for the transmission of group-addressed (e.g., multicast or broadcast) frames, since the duration field is set to zero for group-addressed frames. Also, request-to-send (RTS) and clear-to-send (CTS) messages have been used only for transmission of unicast frames, and are not used for the transmission of a group-addressed frame. Therefore, without NAV protection and/or without RTS/CTS protection for group-addressed frames, a wireless station may typically be able to transmit only a single group-addressed frame within a single transmission opportunity (TXOP). If a station has multiple group-addressed frames to transmit, the station may be required to contend and obtain a TXOP for each group-addressed frame to be transmitted. Thus, transmitting only one group-addressed frame per TXOP may be an inefficient approach where there are multiple group-addressed frames to be transmitted.

According to an example embodiment, a first wireless station (e.g., a first mesh station) or device may provide NAV protection for the transmission of a plurality (or multiple) group-addressed (e.g., multicast or broadcast) frames during one transmission opportunity (TXOP) by transmitting a first message to a second (individually addressed) wireless station (or device), where the duration field of the first message is set to a non-zero value, e.g., set to a value of the duration of the TXOP to transmit multiple group-addressed frames. If the second wireless station successfully (e.g., without collision or error) receives the first message, the second wireless station then transmits a second message to the first wireless station in reply to the first message, where the duration field of the second message is set to a non-zero value (e.g., indicating a duration or remaining duration of the TXOP). The transmission of the second message with a non-zero duration field increases a range of the NAV protection for the transmission of multiple group-addressed frames for the TXOP, and may decrease the probability of collisions or interference from hidden nodes (e.g., based on the communication of the non-zero duration field in the second message to other wireless stations). The second message may provide a feedback mechanism to the first wireless station that indicates that the first wireless station is (likely) currently the only transmitter (within range of the first wireless station), and the first wireless station may therefore safely continue transmitting multiple group-addressed frames for the remaining duration of the TXOP. The first wireless station may then transmit the multiple (or plurality of) group-addressed frames, setting a duration field of each group-addressed frame to a remaining duration of the TXOP. In this manner, multiple group-addressed frames may be transmitted within a single TXOP.

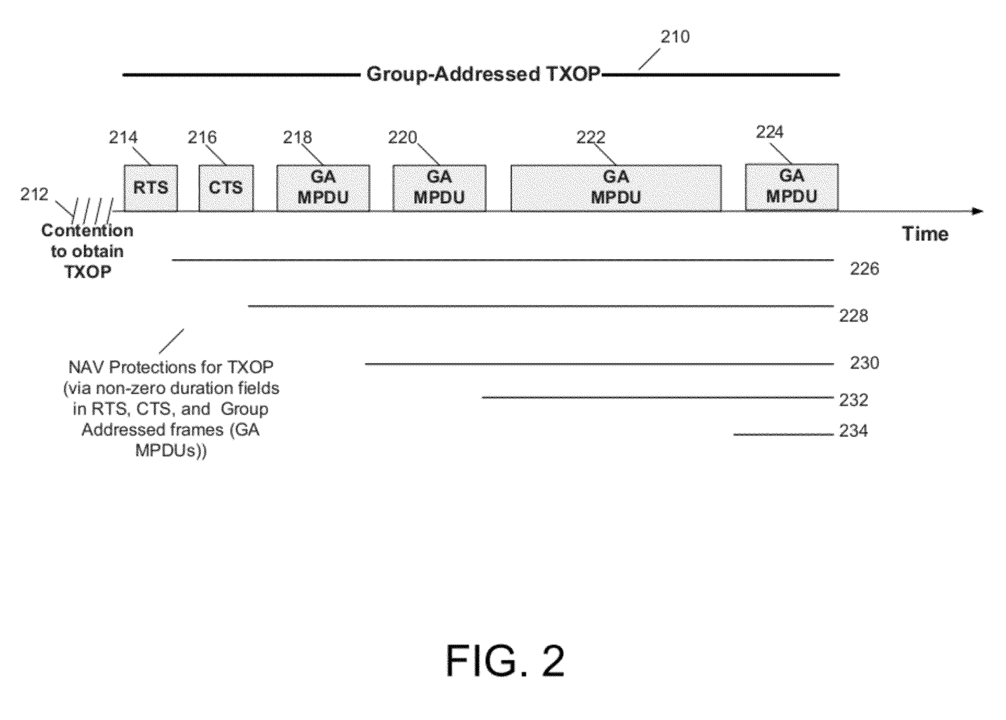

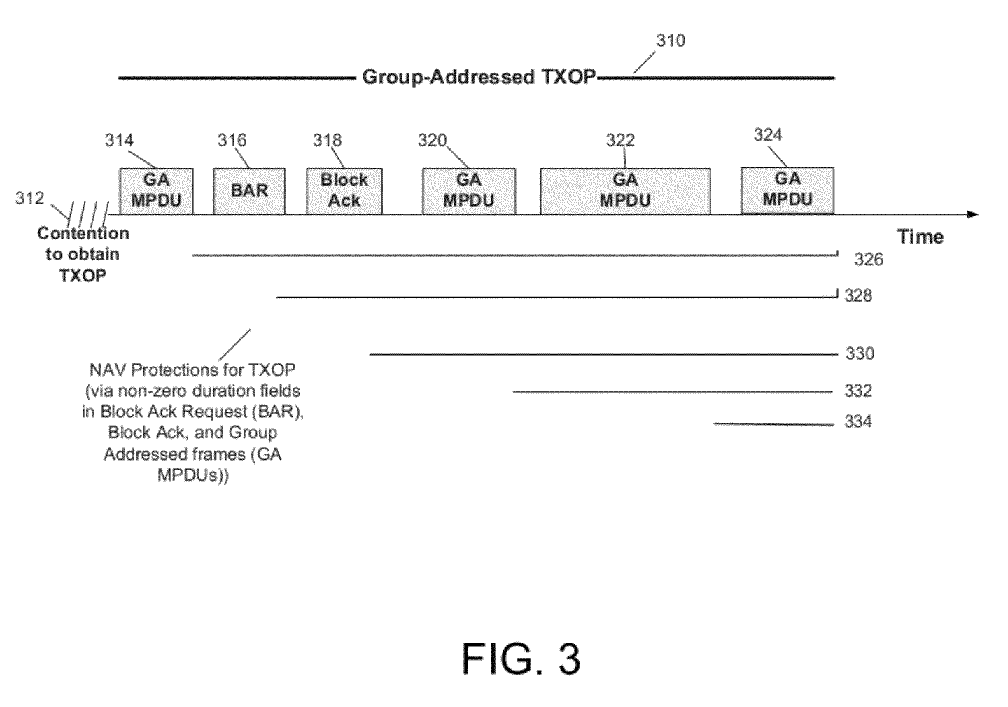

In one example implementation, the first and second wireless stations may each be mesh stations (e.g., mesh point, mesh portal or a mesh access point). In another example implementation, the first and second wireless stations may be a mobile station or an access point (AP), or any other type of wireless stations. In one example implementation the first and second messages may be control messages. In an example implementation, the first and second messages may be a request-to-send (RTS) message and a clear-to-send (CTS) message, respectively. This example implementation is described with reference to FIG. 2. In another example implementation, the first and second messages may include a block acknowledgement request (or block ack request) for group-addressed frames and a block acknowledgement for one or more group-addressed frames, respectively. This example implementation is described with reference to FIG. 3. In another example implementation, the first and second messages may include a data frame (such as a group-addressed data frame) and an acknowledgement to the data frame (such as a block acknowledgement for the group-addressed frame), respectively. Other types of control messages may be used, as these are merely some example implementations.

FIG. 2 is a diagram illustrating the transmission of multiple group-addressed frames in one transmission opportunity (TXOP) based on the use of request-to-send (RTS) and clear-to-send (CTS) messages. A first wireless station (e.g., mesh station 122) may have a plurality of group-addressed frames (e.g., broadcast frames addressed to a broadcast address, or multicast frames addressed to a multicast group address) to be transmitted. The first wireless station may obtain a transmission opportunity (TXOP) by using a contention based channel access mechanism. Thus, at 212 (FIG. 2), the first wireless station may contend for access to obtain a TXOP 210 for the transmission of group-addressed frames. The duration of the TXOP 210 for transmission of group-addressed frames 210 is shown by line 210.

To contend for channel access to obtain the TXOP 210, the first wireless station may use, for example, both virtual carrier-sense and physical carrier-sense functions to determine the availability of the shared medium or channel. For example, the medium may be considered to be idle when both of these two functions indicate that the medium is idle. While the physical carrier-sense function uses the physical layer to sense the carrier, the virtual carrier-sense function is based on the Network Allocation Vector (NAV). For example, most IEEE 802.11 frames may carry a duration field (e.g., in the MAC header of each frame), which may be used to reserve the medium (or channel) for a fixed time period. The reserved time period is indicated by the value of the duration field. Each device in the network 102 may include a NAV timer that indicates the amount of time for which the medium has been reserved. Transmitting nodes may set the duration field to a value indicating the time for which they expect to use the medium, including the transmission time of all the frames in a sequence, or the duration of the TXOP. Other nodes in the network may set up a process to count down their NAV timer. When the NAV is greater than zero, the virtual carrier-sense function indicates that the medium is busy. When the NAV reaches zero, the medium is reported to be idle.

In an example implementation, after at least one of physical carrier sense and virtual carrier sense indicate that the channel is idle, a transmitting station (e.g., the first wireless station) waits the necessary interval, and then generates a random backoff number within a range. The transmitting station decrements the backoff counter until it reaches zero. If the wireless media is still idle (as indicated by both virtual carrier sense and physical carrier sense functions) when the backoff counter reaches zero, the transmitting station may transmit. If it is not idle, the station may select another random backoff number within a larger range, and repeats the process. This illustrates one example of how a station may contend for wireless channel access to obtain a transmission opportunity. Other techniques may also be used.

Referring to FIG. 2 again, after obtaining the transmission opportunity (TXOP) 210, the first wireless station may select another (e.g., a second) wireless station (e.g., mesh station 124) to receive the request-to-send (RTS) message. The first wireless station may then transmit a request-to-send (RTS) message 214 to the selected second wireless station. The RTS message 214 may be a unicast message having a destination address set to the individual address of the selected second wireless station.

The RTS message 214 also includes a non-zero duration field that indicates a duration of the TXOP 210 (or the duration or period of time for which the first wireless station is reserving the wireless channel/medium to transmit the multiple group-addressed frames within the TXOP 210). Thus, since TXOP 210 will be used to transmit group-addressed frames, TXOP 210 may be referred to as a group-addressed TXOP 210. In one example implementation, the duration of the TXOP 210 (and as indicated in the RTS duration field) is typically less than or equal to a maximum TXOP duration for the transmission of multiple group-addressed frames. The maximum TXOP duration for multiple group-addressed frames may be referred to as Group Addressed TXOP Limit, for example.

While the group-addressed frames to be transmitted will be addressed to a group of stations (e.g., frames with a destination address set to a broadcast address or set to a multicast group address), the RTS message 214 is a unicast message or frame transmitted to one of multiple wireless stations. Thus, for the RTS message 214, the source address may be set to the MAC address of the transmitting station (e.g., the first wireless station), and the destination address is set to the individual MAC address of the selected or identified second wireless station (the second wireless station).

A number of different techniques may be used to select or identify a second wireless station to receive the RTS message 214 (this is also selecting which station should reply with a clear-to-send (CTS) message, e.g., selecting a CTS transmitter). In one example implementation, a second wireless station may be selected randomly from a group of wireless stations, e.g., from a group of neighbor or peer mesh stations. For example, mesh station 122 may select either mesh station 120 or mesh station 124 to receive the RTS message 214.

In another example implementation, the wireless station may keep track of the status of each neighbor or peer stations as being in either active mode (fully on and listening), or in a power saving or sleep mode where the wireless station may apply power to or activate various circuits in the station only to receive beacons from one or more peer stations, and otherwise may be in a sleep or power saving mode. The first wireless station may then select (e.g., randomly) one of the peer wireless stations that are in active mode. The active mode station is more likely to receive the RTS message (since the power saving or sleep mode station is more likely to be sleeping or in power saving mode), and the active mode stations will likely have more accurate NAV information with respect to other stations. Therefore, it may be advantageous to select one of the wireless stations that are in active mode (not in sleep or power saving mode).

In an alternative implementation, a wireless station may determine a source transmitter of one or more of the group-addressed frame(s) to be transmitted or forwarded. For example, a group-addressed data frame may be received and buffered for forwarding by mesh station 122, with a field in the group-addressed data frame (or other indication being provided) that indicates that the group-addressed frame comes from (or is transmitted from) Internet 110 via mesh station 120. Thus, for example, a source address (or source transmitter) field in the group-addressed data frame may identify (for example) mesh station 120 (as a mesh portal) as the source or source transmitter of the group-addressed frame to be transmitted. Thus, in this example, mesh station 122 may select a wireless station to receive the RTS message that is not a source transmitter (e.g., not mesh station 120) of the group-addressed data frame, nor on a path between the current station (mesh station 122) and the source transmitter 120. Thus, mesh station 122 may select mesh station 124 as the second wireless station to received the RTS message (e.g., to be the CTS transmitter). By selecting a mesh station that is not the source transmitter or on a path between the current station and the source transmitter of the group-addressed data frame to be forwarded, this will increase the NAV protection for such group-addressed data frames in an area or region of network 115 where such frames should be forwarded or towards the destination(s) of such group addressed frames, e.g., away from the source transmitter or origin of such frames. Since such group addressed frames have already passed through mesh station 120 (in this example), it may be advantageous to increase NAV protection for these messages in areas of the network 115 where the frames have not yet been transmitted into, for example, near or towards mesh station 124. Therefore, in this example, since the group-addressed frame(s) are transmitted from (or received from) Internet 110 via mesh station 120, mesh station 122 may select mesh station 124 to receive the RTS message 214.

Similarly, various selection techniques may be combined. For example, among a group of active mesh stations, an active mesh station may be selected to receive the RTS message 214 that is not a source transmitter nor on a path between the first (or current) wireless station and the source transmitter (or origin of the frame).

Referring to FIG. 2 again, the selected wireless stations (e.g., second wireless station) may receive the RTS message 214. In response to the RTS message 214, the second wireless station may then transmit a clear-to-send (CTS) message 216 back to the first wireless station to indicate that the media is (or appears to be) idle and available for the first wireless station to continue using to transmit other frames during the TXOP 210. The CTS message 216 may be, for example, a unicast message having a source address set to the address of the second wireless station and a destination address set to the individual address of the first wireless station, and a duration field set to a non-zero value indicating the remaining duration of TXOP 210. The transmissions of RTS message 214 and CTS message 216 including a non-zero duration fields may provide NAV protection for the transmission of frames during TXOP 210. For example, lines 226 and 228 in FIG. 2 indicate the duration and remaining duration (provided NAV protection) of the TXOP 210 as identified in the duration fields of the RTS message 214 and the CTS message 216, respectively.

If the CTS message 216 is not received by the first wireless station within a timeout period, then the first wireless station, according to an example implementation, does not transmit additional frames until the first wireless station performs contention to obtain another TXOP. Therefore, if a CTS message 216 is not received in reply to the transmitted RTS message 214, then no feedback is provided to the transmitting station (the first wireless station) that confirms or assures the first wireless station that there are no other transmitters transmitting during TXOP 210. Therefore, if no CTS message is received by the first wireless station within a timeout period, then it is possible that another station is also transmitting, e.g., creating a collision in the wireless media, and the first wireless station may typically wait and obtain another TXOP before transmitting additional frames (or before transmitting the one or more group-addressed data frames that may be buffered for transmission). Thus, the first wireless station or transmitting station may defer transmitting the plurality of group-addressed data frames until the first wireless station obtains one or more additional TXOPs, in the event that a CTS message is not received within a timeout period.

However, the CTS message 216 may be received by the first wireless station, thereby indicating that no other stations are likely using the wireless channel at this time, for example. Therefore, if the CTS message 216 is received, the first wireless station may then sequentially or serially transmit each of a plurality of group-addressed data frames (or a plurality of group-addressed MAC protocol data units or GA MPDUs) before expiration or end of the TXOP 210. These plurality of group-addressed data frames transmitted before the expiration of TXOP 210 may include group-addressed data frames (or GA MPDUs) 218, 220 222 and 224, as shown in FIG. 2. The plurality of group-addressed frames may include frames addressed to a broadcast address and/or addressed to a multicast group address. The plurality of group-addressed frames may be addressed to (or have a destination address set to) a same group address or to different group addresses. Each of the transmitted group-addressed data frames, e.g., 218, 220, 222, and 224 may include a non-zero duration field that indicates a remaining duration of the TXOP 210, e.g., to provide additional NAV protection for TXOP 210. Lines 230, 232 and 234 indicate the NAV protection provided by the duration values included within transmitted group-addressed frames 218, 220 and 222, respectively.

FIG. 3 is a diagram illustrating the transmission of multiple group-addressed (e.g., data) frames in one transmission opportunity (TXOP) based on the use of a block acknowledgement request (or block ack request) for group-addressed frames and a block acknowledgement for one or more group-addressed frames. A first wireless station may contend at 312 to obtain a transmission opportunity (TXOP) 310. The first wireless station may send a group-addressed frame (or GA MPDU) 314 (note that group-addressed frame 314 may be transmitted by first wireless station in the current TXOP 310, or in a previous TXOP obtained by the first wireless station).

In addition to maintaining data regarding the status of other wireless stations (e.g., in active mode or in power save mode), stations (including the first wireless station, e.g., mesh station 122) may also store information indicating which (if any) other wireless stations are capable of transmitting block acknowledgements (or Block Acks) for group-addressed frames. The first wireless station may identify or select a wireless station that is capable of providing a block acknowledgement for group-addressed frames, e.g., select one of the Block Ack (for group-addressed frames) capable stations that are in active mode, and/or are located away from a transmitter of one or more group-addressed frames to be transmitted. The first wireless station may then transmit a block acknowledgement request (BAR) 316 for group-addressed frames to the identified or selected second wireless station.

Note, that the group-addressed frame 314 may be transmitted before or after the block acknowledgement request for group-addressed frames 316. For example, if the block acknowledgement request 316 is transmitted before the transmission of any group-addressed frames (e.g., before group-addressed frame 314 and others), then the block acknowledgement request for group addressed frames 316 may be a block acknowledgement request for group-addressed frames that were transmitted by the first wireless station during a previous TXOP (prior to TXOP 310), not shown, for example. Or, if the block acknowledgement request (BAR) 316 is transmitted after the group-addressed frame 314 (as shown in the example in FIG. 1), then the block acknowledgement request 316 may be a block ack request for the group-addressed frame 314, for example. These are merely some examples and the disclosure is not limited thereto.

The second wireless station may receive the block acknowledgement request (BAR) 316 for group-addressed frames, and may transmit back to the first wireless station a block acknowledgement 318 that may acknowledge receipt of one or more group-addressed frames (e.g., acknowledge receipt of one or more group-addressed data frames), such as acknowledging receipt of group-addressed frame 314, for example. The block acknowledgement request 316 may be a unicast message having a source address set to the MAC address of the first wireless station (the transmitting station) and a destination address set to the MAC address of the second (receiving) wireless station. Similarly, the block acknowledgement 318 may be a unicast message having a source address set to the MAC address of the second wireless station and a destination address set to the MAC address of the first wireless station.

The group-addressed data frame 314 may include a non-zero duration field that indicates the duration of the TXOP 310 (or the duration that the channel or media is reserved for the TXOP 310). The duration of TXOP 310 may be, for example, less than or equal to a maximum TXOP for transmission of multiple group-addressed frames, which may be referred to as Group_Addressed_TXOP Limit. Both the block acknowledgement request 316 and the block acknowledgement 318 may include a duration field set to a non-zero value that may indicate a remaining duration of TXOP 310, which may provide additional NAV protection for the TXOP 310. Lines 326, 328 and 330 in FIG. 3 identify the NAV protection provided by the transmission frames/messages 314, 316 and 318, respectively.

The first station may receive the block acknowledgement 318 from the second wireless station, which may acknowledge receipt by the second wireless station of one or more group-addressed frames (such as group-addressed frame 314). Receipt of block acknowledgement 318 may provide feedback to the first wireless station that indicates that there is (likely) no other stations within range of the first wireless station currently transmitting, and therefore, the first wireless station may continue transmitting one or more additional group-addressed frames until the expiration or end of the TXOP 310. Thus, for example, the receipt of the block acknowledgement 318 for the group-addressed frame 314 provides some assurance that there is not another wireless station transmitting or attempting to transmit frames (e.g., group-addressed frames or other frames) during TXOP 310, which would create a collision.

After receiving the block acknowledgement 318, the first wireless station then transmits a plurality of (or at least one or more) group-addressed frames, including group-addressed (e.g., data) frames 320, 322 and 324, for example. Group-addressed frames 314, 320, 322 and 324 may be broadcast or multicast frames, and may, in an example embodiment, be addressed to different group addresses, and may each include a non-zero duration value/field to indicate a remaining duration of the TXOP 310. Lines 332 and 334 in FIG. 3 identify the NAV protection provided by the non-zero duration fields in frames 320 and 322, respectively.

In addition, it is possible that the first wireless station may not receive the block acknowledgement 318 for group-addressed frames until after expiration of a particular time period or timeout period. In an example implementation, the first wireless station does not transmit data frames 320, 322 or 324 in TXOP 310, due to possible presence of another transmitting station (as indicated by failure to receive the block acknowledgement 318 within a timeout period. Therefore, in an example implementation, the first wireless station may defer transmission of one or more of the plurality of group-addressed frames (e.g., frames 320, 322 and 324) until the first wireless station obtains a further transmission opportunity (TXOP) if the block acknowledgement 318 for group-addressed frames is not received within a timeout period.

In yet another example implementation, the first station may transmit a data frame, such as a group-addressed data frame as the first message, with a non-zero duration field of the group-addressed frame indicating a duration of the TXOP. The second station may reply to the received group-addressed data frame by transmitting an acknowledgement, such as a block acknowledgement to the received group-addressed frame. The acknowledgement may also include a non-zero duration field indicating a remaining duration of the TXOP.

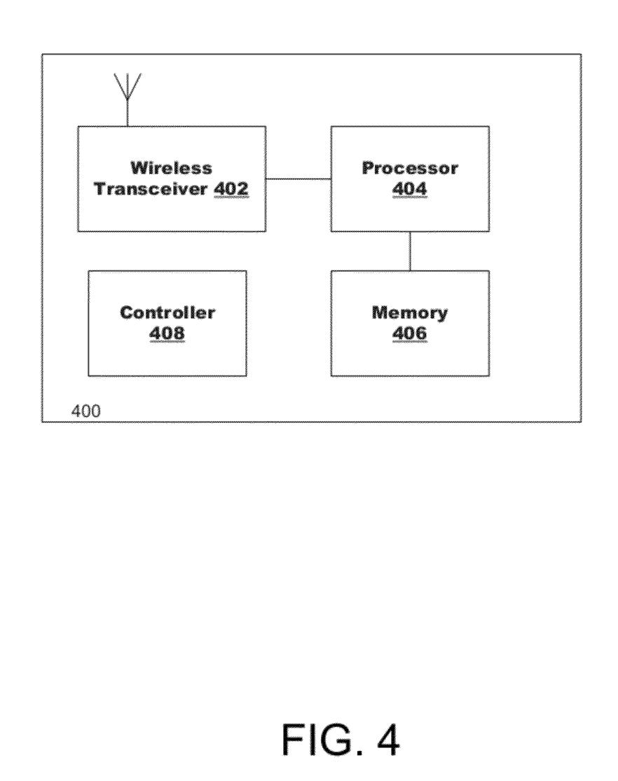

FIG. 4 is a block diagram of an example implementation of a wireless station, or a system or that may be provided at or as part of a wireless station (e.g., mesh station, base station/AP, mobile station, or other wireless station). An example device provided at a wireless station may include one or more of the blocks shown in FIG. 4. The station 400 may include, for example, an RF (radio frequency) or wireless transceiver 402, including a transmitter to transmit signals and a receiver to receive signals, a processor 404 to execute instructions or software and control transmission and receptions of signals, and a memory 406 to store data and/or instructions that are executable by processor 404 to cause the station 400 to perform various functions described herein.

Processor 404 may also make decisions or determinations, generate frames or messages for transmission, decode received frames or messages for further processing, and other tasks or functions described herein. Processor 404, which may be a baseband processor, for example, may generate messages, packets, frames or other signals for transmission via wireless transceiver 402. Thus, processor 404 may transmit and/or receive messages or data via wireless transceiver 402. Processor 404 may control transmission of signals or messages over a wireless network, and may receive signals or messages, etc., via a wireless network (e.g., after being down-converted by wireless transceiver 402, for example). Processor 404 may be programmable and capable of executing software, firmware, or other instructions stored in memory or on other computer media to perform the various tasks and functions or methods described herein. Processor 404 may be (or may include), for example, hardware, programmable logic, a programmable processor that executes software or firmware, and/or any combination of these. Using other terminology, processor 404 and transceiver 402 together may be considered as a wireless transmitter/receiver system, for example.

In addition, a controller (or processor) 408 may execute software and instructions, and may provide overall control for the station 400, and may provide control for other systems not shown in FIG. 4, such as controlling input/output devices (e.g., display, keypad), and/or may execute software for one or more applications that may be provided on wireless station 400, such as, for example, an email program, audio/video applications, a word processor, a Voice over IP application, or other application or software.

In addition, a storage medium, such as memory 406, may be provided that includes stored instructions, which when executed by a controller or processor may result in the processor 404, or other controller or processor, performing one or more of the functions or tasks described herein.

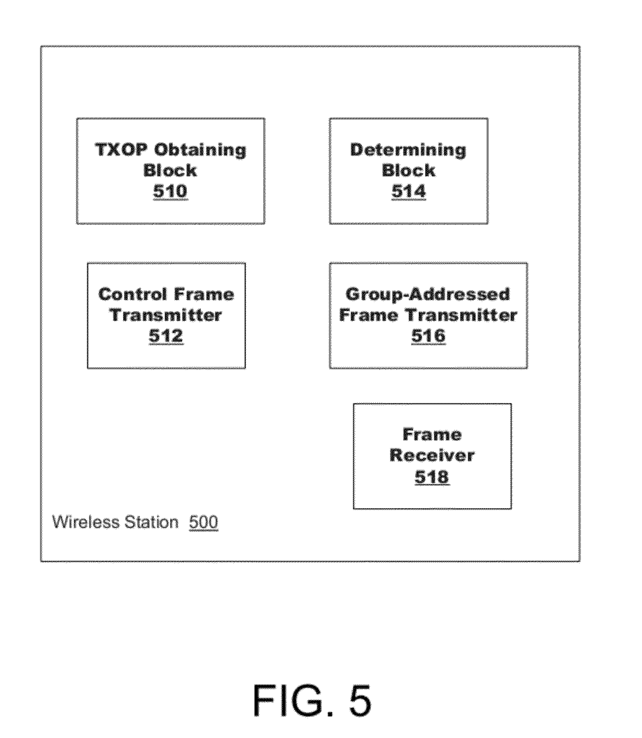

FIG. 5 is a block diagram of a wireless station 500 according to another example implementation. An example device provided at a wireless station may include one or more blocks of FIG. 5. Each of the blocks 510, 512, 514, 516 and 518 may include may include hardware, software and other circuits to perform the associated or described operations or functions. Wireless station 500 may include a TXOP obtaining block 510, which may include hardware, software and other circuits that are involved in contending for channel access and obtaining one or more transmission opportunities (TXOPs), where each TXOP may be used to transmit a plurality of frames including a plurality of group-addressed frames. Control frame transmitter 512 (which may be implemented by transceiver 402 and processor 404) may transmit control frames/messages, such as request-to-send (RTS) messages, clear-to-send (CTS) messages, a block acknowledgement request for group-addressed frames, a block acknowledgement for one or more group-addressed frames, and other types of control or management frames or messages. A frame receiver 518 is provided to receive frames, such as the first or second messages, control messages, RTS messages, CTS messages, group-addressed data frames, block ack requests and block acks and other frames or messages. Frame receiver 518 may be implemented, for example, by wireless transceiver 402 and processor 404. A determining block 514 (which may be implemented, for example, by processor 404 programmed with computer instructions or software) may determine if one or more particular types of messages have been received, such as a clear-to-send (CTS) message, a block acknowledgement from one or more group-addressed frames, or other types of frames or messages. In an example implementation, once determining block 514 has determined or detected that such a control frame (e.g., CTS, acknowledgement or block ack for group-addressed frames) has been received by the station, the station may then, for example, transmit one or more (or a plurality of) group-addressed data frames before the expiration of the TXOP. A group-addressed frame transmitter 516 (which may be implemented, for example, by transceiver 402 and processor 404) may transmit each of a plurality of group-addressed data frames.

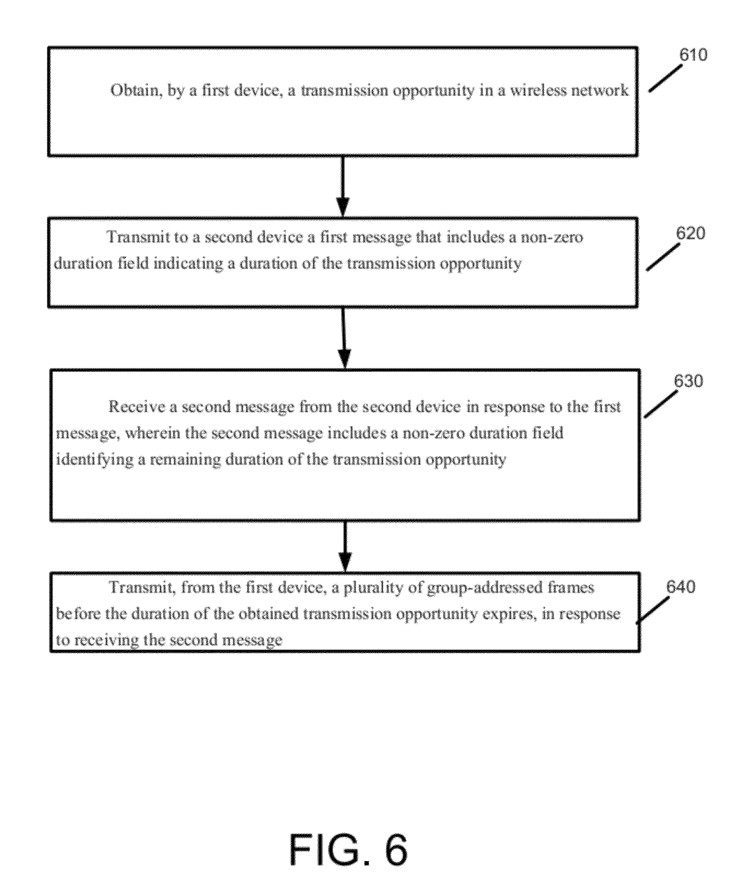

FIG. 6 is a flow chart illustrating operation of a wireless station according to an example embodiment. Operation 610 includes obtaining, by a first device, a transmission opportunity in a wireless network. Operation 620 includes transmitting to a second device a first message that includes a non-zero duration field indicating a duration of the transmission opportunity. Operation 630 includes receiving a second message from the second device in response to the first message, wherein the second message includes a non-zero duration field identifying a remaining duration of the transmission opportunity. And, Operation 640 includes transmitting, from the first device, a plurality of group-addressed frames before the duration of the obtained transmission opportunity expires, in response to receiving the second message.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various implementations.

What is claimed is:

1. An apparatus comprising:
at least one processor;
at least one memory including computer program code, the at least one memory and the computer program code configured to, with the at least one processor cause the apparatus to at least:
obtain, by a first device, a transmission opportunity in a wireless network;
transmit to a second device a first message that includes a non-zero duration field indicating a duration of the transmission opportunity;
receive a second message from the second device in response to the first message, wherein the second message includes a non-zero duration field identifying a remaining duration of the transmission opportunity; and
transmit, from the first device, a plurality of group-addressed frames before the duration of the obtained transmission opportunity expires, in response to receiving the second message.

2. The apparatus of claim 1 wherein the first message comprises a block acknowledgement request for group-addressed frames, and the second message comprises a block acknowledgement for one or more group-addressed frames sent in response to the block acknowledgement request.

3. The apparatus of claim 1 wherein the first message comprises a request-to-send (RTS) message, and the second message comprises a clear-to-send (CTS) message sent in response to the RTS message.

4. The apparatus of claim 1 wherein the first message comprises a group-addressed data frame and the second message comprises an acknowledgement to the group-addressed data frame.

5. The apparatus of claim 1 wherein the duration of the obtained transmission opportunity being less than or equal to a group-addressed transmission opportunity limit.

6. The apparatus of claim 1 wherein the apparatus being configured to obtain comprises the apparatus being configured to use a contention-based channel access to obtain the transmission opportunity.

7. The apparatus of claim 1 wherein the apparatus being configured to transmit to a second device a first message comprises:
identify a second device that is in active mode; and
transmit to the second device a first message that includes a non-zero duration field indicating a duration of the transmission opportunity.

8. The apparatus of claim 1 wherein the apparatus being configured to transmit to a second device a first message comprises:
identify a second device that is not a source transmitter of the plurality of group-addressed frames nor on a path between the source transmitter of the group-addressed frames and the first device.
transmit to the second device a first message that includes a non-zero duration field indicating a duration of the transmission opportunity.

9. The apparatus of claim 1 wherein one or more of the plurality of group-addressed frames includes a non-zero duration field identifying a remaining duration of the transmission opportunity.

10. The apparatus of claim 1 wherein the first message is a first unicast control message having a destination address field set to an address of the second device, the second message is a second unicast control message having a destination address field set to an address of the first device, and each of the plurality of group-addressed frames includes a destination address field set to a broadcast address or a multicast group address.

11. The apparatus of claim 1 wherein the first message is a group-addressed data frame, the second message is a unicast control message having a destination address set to an address to the first device, and each of the plurality of group-addressed frames includes a destination address set to a broadcast address or a multicast group address.

12. The apparatus of claim 1 wherein the first and second devices comprise devices provided at wireless mesh stations.

13. A method comprising:
obtaining, by a first device, a transmission opportunity in a wireless network;
transmitting to a second device a first message that includes a non-zero duration field indicating a duration of the transmission opportunity;
receiving a second message from the second device in response to the first message, wherein the second message includes a non-zero duration field identifying a remaining duration of the transmission opportunity; and
transmitting, from the first device, a plurality of group-addressed frames before the duration of the obtained transmission opportunity expires, in response to receiving the second message.

14. The method of claim 13 wherein the first message comprises a block acknowledgement request for group-addressed frames, and the second message comprises a block acknowledgement for one or more group-addressed frames sent in response to the block acknowledgement request.

15. The method of claim 13 wherein the first message comprises a request-to-send (RTS) message, and the second message comprises a clear-to-send (CTS) message sent in response to the RTS message.

16. The method of claim 13 wherein the first message comprises a group-addressed data frame and the second message comprises an acknowledgement to the group-addressed data frame.

17. The method of claim 13 wherein one or more of the plurality of group-addressed frames includes a non-zero duration field identifying a remaining duration of the transmission opportunity.

18. The method of claim 13 wherein the first message is a first unicast control message having a destination address field set to an address of the second device, the second message is a second unicast control message having a destination address field set to an address of the first device, and each of the plurality of group-addressed frames includes a destination address field set to a broadcast address or a multicast group address.

19. The method of claim 13 wherein the first message is a group-addressed data frame, the second message is a unicast control message having a destination address set to an address to the first device, and each of the plurality of group-addressed frames includes a destination address set to a broadcast address or a multicast group address.

20. A computer program product tangibly embodied on a computer-readable storage medium having executable-instructions stored thereon, the instructions being executable to cause a processor to:
obtain, by a first device, a transmission opportunity in a wireless network;
transmit to a second device a first message that includes a non-zero duration field indicating a duration of the transmission opportunity;
receive a second message from the second device in response to the first message, wherein the second message includes a non-zero duration field identifying a remaining duration of the transmission opportunity; and
transmit, from the first device, a plurality of group-addressed frames before the duration of the obtained transmission opportunity expires, in response to receiving the second message.
